(19) United States
(12) Patent Application Publication
(10) Pub. No.: US 2024/0327252 A1
(43) Pub. Date: Oct. 3, 2024

(54) MOBILE MODULAR RESOURCE SYSTEM AND METHODS OF USE THEREOF

(71) Applicant: Joseph Michael STEVENS, Statham, GA (US)

(72) Inventor: Joseph Michael STEVENS, Statham, GA (US)

(21) Appl. No.: 18/611,317

(22) Filed: Mar. 20, 2024

Related U.S. Application Data
(60) Provisional application No. 63/493,520, filed on Mar. 31, 2023.

(51) Int. Cl. C02F 1/44; B60P 3/22; B60R 16/03; H02J 3/38; H02J 7/00

(52) U.S. Cl. CPC C02F 1/441; B60P 3/225; B60R 16/03; H02J 3/38; C02F 2201/008; C02F 2201/009; C02F 2209/008; H02J 7/0029; H02J 2300/24; H02J 2300/28

(57) ABSTRACT

The invention is directed towards a modular, mobile resource system. Such system is capable of being deployed to a variety of remote, disaster-stricken, or emergency situations to provide needed resources. Such system is capable of being configured in a variety of ways by coupling, uncoupling, re-configuring, and otherwise adjusting subsystems and components within the system. Example subsystems include power-supplying subsystems, water-producing subsystems, and the like.

### CROSS-REFERENCE TO RELATED APPLICATIONS

This invention claims priority from U.S. Provisional Patent Application Ser. No. 63/493,520, filed Mar. 31, 2023, which is incorporated by reference in their entirety herein.

### TECHNICAL FIELD OF THE INVENTION

The present disclosure relates to mobile and modular resource systems.

### BACKGROUND OF THE INVENTION

Humans, regardless of their location, require access to a variety of resources. Resources at a bare minimum may include water, food, and shelter. Additional resources can include electricity, communication, and other such resources used by humans. These resources can be scarce in a variety of locations for a variety of reasons. In a barren dessert, water will scarcely be found. In the wake of a hurricane or other natural disasters, electricity and many other resources are hard to locate.

Therefore, there is a need for a system and components to address the issues described above.

### SUMMARY OF THE INVENTION

It is to be understood that this summary is not an extensive overview of the disclosure. This summary provides examples and is not restrictive, and it is intended to neither identify key or critical elements of the disclosure nor delineate the scope thereof. The sole purpose of this summary is to explain and exemplify certain concepts of the disclosure as an introduction to the following complete and extensive detailed description.

The present disclosure relates a modular, mobile resource system. Such system is capable of providing resources to remote areas, disaster-stricken areas, conflict zones, and emergency-stricken areas. An example system can include a body, a wheel subsystem, a power-supplying subsystem, and a wide variety of additional subsystems and components depending on a desired application, as described herein.

Bodies of a modular, mobile resource system include a wide variety of widths and lengths. Bodies can include a floor, walls, and a ceiling. Such bodies are configured to couple to one or more of a variety of subsystems and components disclosed herein. Bodies can additionally be made from a variety of materials including but not limited to woods, metals, hard plastics, fiberglass, and carbon fiber.

Power-supplying subsystems may include renewable power sources. Such renewable power sources may include but are not limited to a solar panel, an array of solar panels, a wind turbine, an array of wind turbines, a hydro turbine, an array of hydro turbines, any combinations thereof, and the like. Power-supplying subsystems may further include charge controllers to prevent battery shorting, charge meters, shunts, fuses, battery banks, control units, a housing unit, and other power-related components. Power-supplying subsystems are capable of supplying power to a variety of other subsystems and components. As non-limiting examples, power-supplying subsystems are capable of supplying power to water-producing subsystems, telecommunication subsystems, distillation subsystems, power tool subsystems, refrigeration subsystems, air conditioning subsystems, cooking subsystems, bathing subsystems, charging stations for phones, tablets, and computers, lighting subsystems, and speaker subsystems.

Modular, mobile resource systems may also include water-producing subsystems. Such water-producing subsystems may include a water filtration system suitable for producing potable water (e.g., reverse osmosis (RO) system), a booster pump, a water storage device, a water cleaning unit, and any combinations thereof. Water-producing subsystems may further include water-dispersion units that include but are not limited to troughs, faucets, sinks, and the like.

The modular, mobile resource system may further include a telecommunication subsystem. Telecommunication subsystems may include but are not limited to at least one radio, an antenna, and a Wi-Fi capable device.

The modular, mobile resource system may also include at least one protective subsystem. Protective subsystems include but are not limited to anchors, armor, and theft prevention devices.

The modular, mobile resource system may further include power tool subsystems. Power tool subsystems can include but are not limited to a number of power tools and outlets to power the number of power tools.

The modular, mobile resource system may further include a distillation subsystem for producing ethanol. Such a distillation subsystem may include a mill, a steep tank, an ethanol fermenter, one or more filtration systems, a physical separation device, a distillation column, a storage tank to store produced ethanol, and any additional distillation components.

### BRIEF DESCRIPTION OF DRAWINGS

The features and components of the following figures are illustrated to emphasize the general principles of the present disclosure. Corresponding features and components throughout the figures can be designated by matching reference characters for the sake of consistency and clarity.

FIG. 1 displays a view of an example embodiment of a modular, mobile resource system of the present disclosure including an example power source array support.

FIG. 2 displays a view of an example embodiment of a modular, mobile resource system of the present disclosure including an example power source array support.

FIG. 3 displays a side view of an example embodiment of a modular, mobile resource system of the present disclosure including an example power source array support and an actuator.

FIG. 4 displays a diagonal view of an example embodiment of a modular, mobile resource system of the present disclosure including an example power source array.

FIG. 5 displays a view of an example configuration of a modular, mobile resource system of the present disclosure including several example subsystems and components.

FIG. 6 displays a view of an example embodiment of a modular, mobile resource system of the present disclosure including several example subsystems and components.

FIG. 7 displays a top view of an example embodiment of a modular, mobile resource system of the present disclosure including an example power source housing and several components therein.

FIG. 8 displays a view of an example embodiment of a modular, mobile resource system of the present disclosure including an example water-producing subsystem.

FIG. 9 displays a view of an example embodiment of a modular, mobile resource system of the present disclosure including an example telecommunications subsystem.

FIG. 10 displays a view of an example embodiment of a modular, mobile resource system of the present disclosure including an example telecommunications subsystem.

FIG. 11 displays a view of an example embodiment of a modular, mobile resource system configuration of the present disclosure including several example subsystems and components.

FIG. 12A-12B display views of example anchoring components of the present disclosure.

FIGS. 13A-13B display views of example Faraday cages capable of use in example embodiments according to the present disclosure.

FIG. 14 displays a flow chart demonstrating an example embodiment of the present disclosure including multiple modular components.

FIG. 15 displays a flow chart demonstrating an example embodiment of the present disclosure including multiple modular components.

FIG. 16 displays a flow chart demonstrating an example embodiment of the present disclosure including multiple modular components.

### DETAILED DESCRIPTION OF THE INVENTION

It should be appreciated that this disclosure is not limited to the systems, subsystems, and components described herein. It is also to be understood that the terminology used herein is for the purpose of describing certain embodiments only, and is not intended to be limiting, since the scope of the present disclosure will be limited only by the appended claims.

Unless defined otherwise, all technical and scientific terms used herein have the same meaning as commonly understood by one of ordinary skill in the art to which this disclosure belongs. Any systems, subsystems, and components similar or equivalent to those described herein can be used in the practice or testing of the present invention. All publications mentioned are incorporated herein by reference in their entirety.

The use of the terms “a,” “an,” “the,” and similar referents in the context of describing the presently claimed invention (especially in the context of the claims) are to be construed to cover both the singular and the plural, unless otherwise indicated herein or clearly contradicted by context.

Recitation of ranges of values herein are merely intended to serve as a shorthand method of referring individually to each separate value falling within the range, unless otherwise indicated herein, and each separate value is incorporated into the specification as if it were individually recited herein.

Use of the term “about” is intended to describe values either above or below the stated value in a range of approx. +/−10%; in other embodiments the values may range in value either above or below the stated value in a range of approx. +/−5%; in other embodiments the values may range in value either above or below the stated value in a range of approx. +/−2%; in other embodiments the values may range in value either above or below the stated value in a range of approx. +/−1%. The preceding ranges are intended to be made clear by context, and no further limitation is implied. All methods described herein can be performed in any suitable order unless otherwise indicated herein or otherwise clearly contradicted by context. The use of any and all examples, or example language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

The present disclosure can be understood more readily by reference to the following detailed description, examples, drawings, and claims, and their previous and following description. However, before the present systems, subsystems, and components are disclosed and described, it is to be understood that this disclosure is not limited to the specific systems, subsystems, and components disclosed unless otherwise specified, as such can, of course, vary. It is also to be understood that the terminology used herein is for the purpose of describing particular aspects only and is not intended to be limiting.

### I. Modular, Mobile Resource Systems and Components Thereof

The present disclosure relates to modular, mobile resource systems 10. The disclosure additionally relates to a wide variety of subsystems, components, and methods of use of resource systems 10. Resource systems 10 address a need for systems and methods to deliver needed resources to areas where they cannot be found or are scarce. These areas include a wide variety of locations that might be scarce of resources including but not limited to remote locations, including but not limited to lakes, mountains, deserts, and the like, emergency zones, disaster zones, combat zones, and the like, as further discussed herein. By configuring a variety of subsystems and components to function within an overall, mobile, and modular resource system 10, resources can be delivered anywhere they are needed. Subsystems and components can be coupled to or configured in the system 10 in a modular fashion to adapt the system 10 to the desired application. As such, subsystems and components disclosed herein are not meant to be exhaustive but rather are illustrative of the present disclosure.

The present disclosure relates to modular, mobile resource systems 10 including at least a mobile body 100. Such body 100 serves as the foundation upon which a system 10 is constructed. Though any surface capable of being mobile and supporting the weight of subsystems and components may serve as a body 100, non-limiting examples include but are not limited to tractor trailers, trailers, pallets, skids, truck beds, planks, boards, cages, cabs, and the like. As such, a wide number of combinations of subsystems and components disclosed herein can be coupled to or placed on the body 100 in application-dependent configurations. Though a wide variety of coupling methods are known in the art, non-limiting examples include but are not limited to stapling, taping, welding, screwing, nailing, chaining, linking, and the like.

Bodies 100 are made mobile through wheel subsystems 200. Wheel subsystems 200 can be coupled to the bottom of a body 100 such that the body 100 can be moved from location to location, as needed. As such, bodies 100 and wheel subsystems 200 may be configured to allow a body to be pulled by a separate device, such as with a tractor-trailer, or by an incorporated device, such as with a truck and an incorporated truck bed. Though wheels can be configured in a variety of designs, a resource system 10 may include at least two, at least three, at least four, at least five, at least six, at least seven, or at least eight wheels within a wheel subsystem 200. Additional components, such as axles, may be used within wheel subsystems 200, as needed.

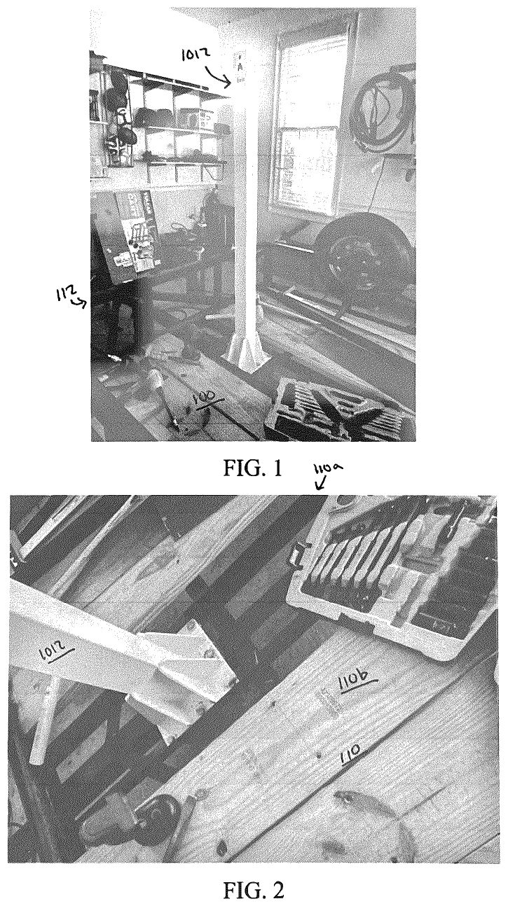

The present disclosure further relates to bodies 100 of a variety of sizes, as shown in FIGS. 1-2. A resource system 10 is scalable to allow for coupling or configuration of additional subsystems and components depending on the application. In order to couple more subsystems and components, a larger body 100 can be selected and transported to a desired location. In order to couple less subsystems and components, a smaller body 100 can be selected and transported to a desired location. Subsystems and components may also simply be remove from a larger body 100 without need for a smaller body 100 in order to decrease the number of subsystems and components being used.

In such examples, a body 100 has a width 102, a length 104, and a height 106. The body 100 may include a floor 110. In some example embodiments, a floor 110 may further include supports 110a running horizontally along the length 104 of the body 100, as shown in FIGS. 1-2. Such supports 110a may be made from a variety of materials. Such materials include but are not limited to metal, plastic, fiberglass, wood, and other such durable materials. In additional, non-limiting examples, a floor 110 including supports 110a may further include one or more elongated surfaces 110b configured to rest on top of said supports 110a, as shown in FIGS. 1-2. Surfaces 110b include but are not limited to boards, slats, planks, and the like. Such surfaces 110b resting on top of supports 110a may be coupled to supports 110a. As shown in FIG. 2, such surfaces 110b may be coupled to supports 110a by being nailed or screwed to supports 110a, though any appropriate means of coupling known in the art is appropriate. Surfaces 110b may also simply be placed on supports 110a without being coupled thereto. The body 100 may additionally include walls 112 and a ceiling 114 if required. As non-limiting examples, subsystems and components may be coupled to one or more of the walls 112, the floor 110, the ceiling 114, or any combination thereof of the body 100. As a non-limiting example, a body 100 including a floor 110, walls 112, and a ceiling 114 may be an enclosed trailer or a similar embodiment capable of being moved using a wheel subsystem 200.

As a non-limiting example a body 100 may include a length 104 of about 3 feet up to about 60 feet, about 5 feet up to about 55 feet, about 10 feet up to about 50 feet, about 15 feet up to about 45 feet, about 20 feet up to about 40 feet, or about 25 feet up to about 35 feet. In such an example, a body 100 may further include a width 102 of about 2 feet up to about 10 feet, about 3 feet up to about 9 feet, about 4 feet up to about 8 feet, or about 5 feet up to about 6 feet. In such an example, a body 100 may also include a height 106 of about 0.5 feet up to about 8 feet. The height 106 of the body 100 is considered to be the height extending from the bottom of a floor 110 to the highest point of the tallest wall 112 or ceiling 114, depending on which is higher. The height 106, as disclosed herein, does not include subsystems or components that may extend beyond the height 106 of the body 110.

The present disclosure additionally relates to bodies 100 including a variety of materials. Materials include all materials that are durable enough to be transported and to support various subsystems and components received by a body 100. Such materials include but are not limited to wood, metals, hard plastics, fiberglass, carbon fiber, and the like.

In examples where a body 100 includes walls 112, a body 100 may include a wall 112 that is capable of movement. In such examples, one wall 112 may be able to be slid up (e.g., semi-trailer), dropped down (e.g., truck bed), or totally removed.

### A. Power-Supplying Subsystem 1000

The present disclosure relates to a variety of subsystems and components. One subsystem includes a power-supplying subsystem 1000. A power-supplying subsystem 1000 includes a power source 1010. Such power source 1010 can be selected from a variety of power sources 1010. Power sources 1010 can be used to supply power to additional subsystems and components disclosed herein. These additional subsystems and components then supply additional capabilities to operators of the system 10.

As a non-limiting example, a power source 1010 may include a source that supplies renewable energy independent of established power lines and grids. In such an example, a power source 1010 may be a solar panel, an array of solar panels, a wind turbine, an array of wind turbines, a hydro turbine (e.g., including but not limited to a dam, a hydroelectric turbine, and the like), an array of hydro turbines, or any combinations thereof. Use of such power sources 1010 is especially advantageous for remote locations, emergency zones, and other locations disclosed herein. Since such sources 1010 operate independently from power lines and power grids that may not be present (e.g., in remote locations) or may be malfunctioning (e.g., during emergencies or disasters), power can more easily be supplied to those in need. Disclosed power sources 1010 are capable of being used in application-dependent fashion. As such, areas where wind is prevalent may use wind turbines. Areas known for high solar output may use solar panels. Areas close to water may use hydro turbines. Additionally, a resource system 10 may include a combination of one or more power source 1010 to account for unexpected factors. As a non-limiting example, a normally sunny area may be cloudy and windy on a given day. A resource system 10 including both solar panels and wind turbines can selectively deploy the wind turbines.

In example embodiments disclosed above concerning arrays of power sources 1010, array supports 1012 may be used, as shown in FIGS. 1-5. An array support 1012 may be coupled to a body 100 of a resource system 10 such that the array support 1012 runs perpendicular to the length 104 of the body 100, as shown in FIG. 1. Various additional orientations are also possible and may be catered to specific applications. As a non-limiting example, the aforementioned perpendicular orientation shown in FIG. 1 may be advantageous for arrays of solar panels. In such an example, solar panels are positioned substantially above a body 100. This allows solar panels to adequately receive solar energy to provide power. As an additional, non-limiting example, an array of hydro turbines may be more advantageous if coupled to the body 100 such that it extends outward from walls 112 of a body 100 (not pictured). Such an orientation may allow for a hydro turbine array to be inserted into nearby water streams.

Array supports 1012 can be joined to a body by a number of means described herein. As shown in FIG. 2, an array support 1012 may be bolted to supports 110a of a floor 110 of a body 100. Many additional coupling techniques can be used including but not limited to stapling, taping, welding, screwing, nailing, chaining, linking, and the like.

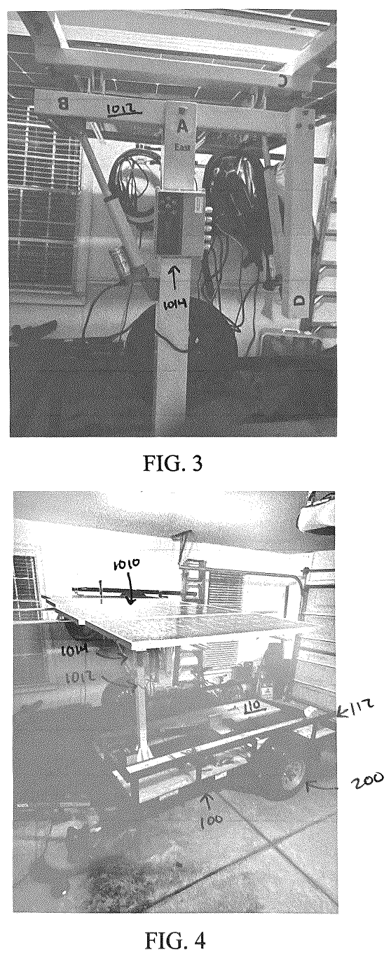

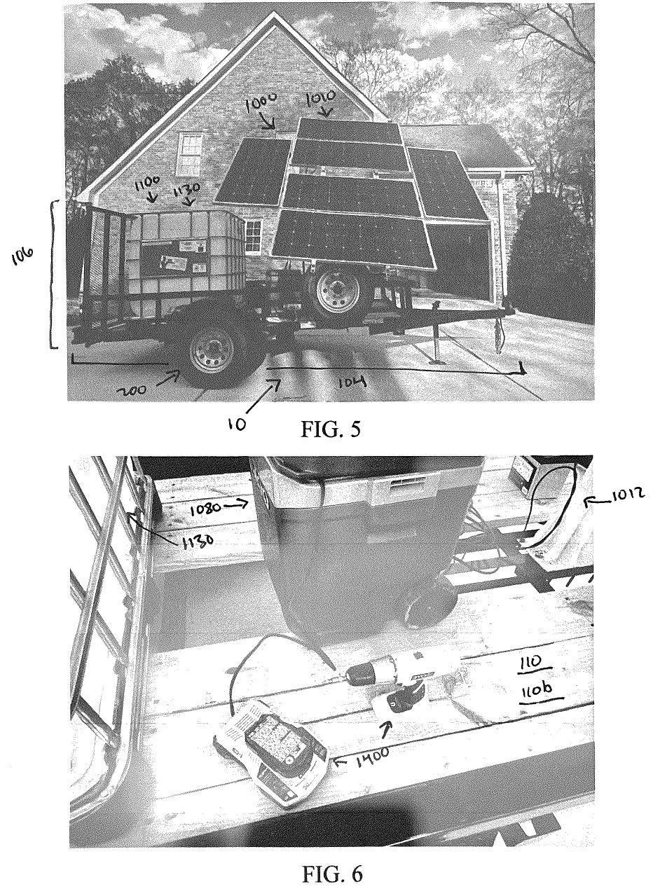

Array supports 1012 can include additional components. As a non-limiting example, an additional component may be designed to optimize performance of an array of power sources 1010. As shown in FIG. 3, an actuator 1014 may be coupled to an array support 1012. Such an actuator 1014 allows arrays of power sources 1010 to track the source of energy that feeds a power source 1010. As a non-limiting example, an actuator 1014 may allow an array of solar panels to automatically track and follow the sun throughout the day without need for operator control. As shown in FIGS. 4-5, this can allow an array of solar panels to transition from an orientation where panels are parallel to a body 100 into an orientation where panels are angled relative to a body 110. A wide variety of angled orientations is possible. This greatly increases energy output for such an array. As an additional, non-limiting example, an actuator 1014 may allow an array of wind turbines to automatically track and follow wind directions throughout the day. This greatly increases energy output for such an array. Though actuators 1014, as previously described, are coupled to power source supports 1012, this is not always necessary. Actuators 1014 can be coupled to many other portions of a resource system 1010 and then connected to a power source 1010. Actuators 1014 can additionally provide actuation to a single power source 1010 (e.g., a single solar panel, wind turbine, or hydro turbine). In such an example, an actuator 1014 does not necessarily have to actuate a whole array of power sources 1010.

The present disclosure relates to multiple configurations of power sources 1010 disclosed herein. Power sources 1010 may be low voltage sources. Voltages can range from about 12 V up to about 48 V. However, this is highly adaptable and can be altered depending on configuration of power source 1010 wiring. As non-limiting examples, power sources 1010 may include an 1170 W, 12 V solar panel, a 400 W, 12 V wind turbine, or any other power sources capable of being configured within the system 10.

As an additional, non-limiting example, wind turbines may also include controllability that allows an operator to manipulate the turbines into a horizontal orientation. This functionality allows an operator to prevent damage to either the system 10 or the power source 1010 in events where wind speeds may be dangerously high. As an additional, non-limiting example, solar panels may also include such functionality. In such an additional example, solar panels may be oriented such that winds do not catch a broad surface of a panel and flip or damage a resource system 10. Controllability for both wind turbines and solar panels may be afforded by one or more actuators 1014, as described above. Such controllability may be automatic.

Power-supplying subsystems 1000 include additional components configured to couple and function with the power source 1010. Additional, non-limiting examples of components include charge controllers 1020 to prevent battery shorting, charge meters 1030, shunts 1040, fuses 1050, battery banks 1060, control units 1070, and other accessories needed to optimize the power system 1000. Battery banks 1060 include but are not limited to deep cell batteries, sealed lead acid batteries, lithium ion batteries, hydrogen fuel cells, and any other battery banks 1060 capable of storing charge received from a power source 1010. As a non-limiting example, such deep cell batteries may be lithium, though more cost effective alternatives are also possible. In such examples, a deep cell battery may be about 1200 Watts.

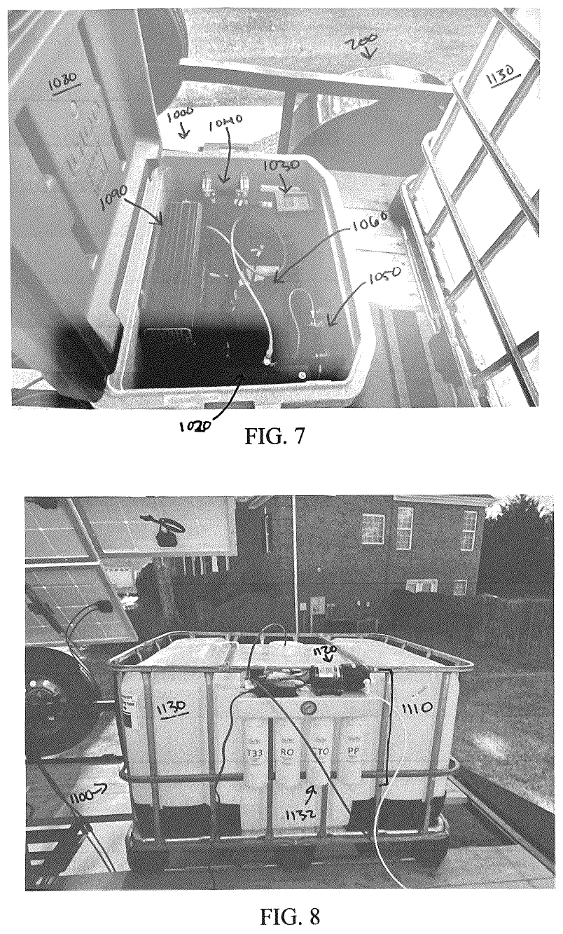

As shown in FIGS. 6-7, power-supplying subsystems 1000 may further include one or more housings 1080 for power sources 1010 and accessories coupled to the power source 1010. Housings 1080 may include a variety of structures configured to retain components within. As a non-limiting example, a housing 1080 may be a cooler. In additional, non-limiting examples, housings 1080 may be self-constructed structures, boxes, insulation, and any structure configured to retain components within. Housings 1080 may include a variety of accessories. Housing 1080 may include locks, trackers, and the like to prevent theft and damage of the components housed therein. Housing 1080 may also be made waterproof and resistant to other natural forces, such as sunlight, animals, and the like, to provide additional protection to subsystems and components retained therein.

The present disclosure additionally relates to power-supplying subsystems 1000 including an inverter 1090. An inverter 1090 may invert voltage flowing from a power source from and to a variety of voltages. As a non-limiting example, an inverter 1090 may invert 12 V, 24 V, or 48 V flowing from a power source 1010 to 100 V, 110 V, 120 V, or any possible voltage in order to power other subsystems and components of the system 10.

### B. Water-Producing Subsystem 1100

The present disclosure relates to a number of subsystems and components capable of being powered by one or more power-supplying subsystems 1000. As a non-limiting example, the present disclosure relates to a water-producing subsystem 1100, as shown in FIG. 8. Such a subsystem 1100 is capable of producing potable water for a variety of animals including humans, horses, dogs, and any other animal requiring water. Such capability is especially valuable in remote and disaster-affected areas where clean drinking water is scarce. Water-producing subsystems 1100 include a filtration system 1110 suitable to convert non-drinkable or unclean water into potable or clean water. As a non-limiting example, a filtration system 1110 may include but is not limited to a reverse osmosis (RO) system or any other such suitable filtration systems or components. Such systems 1110 may be powered by power-producing subsystems 1000 when power is required. As a non-limiting example a filtration system 1110 may be a single-pass unit, though more complex systems can be used if so required by an application. Filtration systems 1110 are capable of producing 400 gallons per day or more of potable water. As a non-limiting example, an example filtration system 1110 is capable of producing about 2000 gallons per day up to about 4000 gallons per day. Filtration systems 1110 can be coupled with pumps 1120, including but not limited to booster pumps, to increase the rate of input into the filtration system 1110. As a non-limiting example, pumps 1120 may be particularly useful for RO systems 1110 where increased water pressure may be required.

Water-producing subsystems 1100 can additionally include one or more storing devices 1130 to store water filtered through a filtration system 1110. Though a variety of devices 1130 exist capable of storing water, non-limiting examples include a water tote, a tanker truck, individual gallon containers, and any other devices capable of storing water. As a non-limiting example, a storing device 1130 can store about 1 gallon at a time up to about 6000 gallons at a time. As a particular example, a storing device 1130 may store about 100 gallons at a time up to about 500 gallons at a time, about 200 gallons at a time up to about 400 gallons at a time, or about 250 gallons at a time up to about 350 gallons at a time. Storing devices 1130 can be multi-purpose. They can both store water and provide anchoring for the resource system 10 in locations where high wind forces may occur. Such storing devices 1130 provide anchoring to a resource system 10 due to the weight of water stored.

Additionally, water storing devices 1130 can be coupled to a variety of subsystems, as shown in FIG. 8 where an example RO system is used. In a non-limiting example, water storing devices 1130 may be coupled to filtration systems 1110. In an additional, non-limiting example, water storing devices 1130 may be coupled to water cleaning units 1132. Water cleaning units 1132 may be disposed on the interior or exterior of a water storing device 1130 as to have access to the water housed within. Cleaning units 1132 assist in keeping water stored in devices 1130 drinkable for longer periods of time compared to water stored in devices 1130 without cleaning units 1132. This allows stored water to continuously be dispersed without risking illness from consumption. In a non-limiting example, a water cleaning unit 1132 may be a housing unit that disperses a water purifying agent at a controlled dispersion rate. In such an example, a water cleaning unit 1132 may disperse chlorine dioxide, hydrogen peroxide, or any other chemical used to clean water.

Water-producing subsystems 1100 may also be coupled to a variety of water-dispersion units 1140. Water-dispersion units 1140 may include a variety of example devices to disperse water as needed. As a non-limiting example, water-dispersion units 1140 may include sinks, faucets, showers, taps, troughs (e.g., for animals), or the like. Such water-dispersion units 1140 may be coupled to other components of a water-producing subsystem 1100 to facilitate dispersion. As such, water-dispersion units may be coupled via pipes, tubes, pumps, and the like directly to a filtration system 1110 or to a water storing device 1130.

### C. Telecommunication Subsystem 1200

The present disclosure additionally relates to telecommunication subsystems 1200. Telecommunication subsystems 1200 allow for operators in remote or disaster-affected locations to be able to communicate with individuals located elsewhere. As a non-limiting example, telecommunication subsystems 1200 may facilitate near vertical incidence skywave (NVIS) communications. Such communications may be especially useful during emergencies and disasters when conventional telecommunication pathways may be disabled temporarily or permanently.

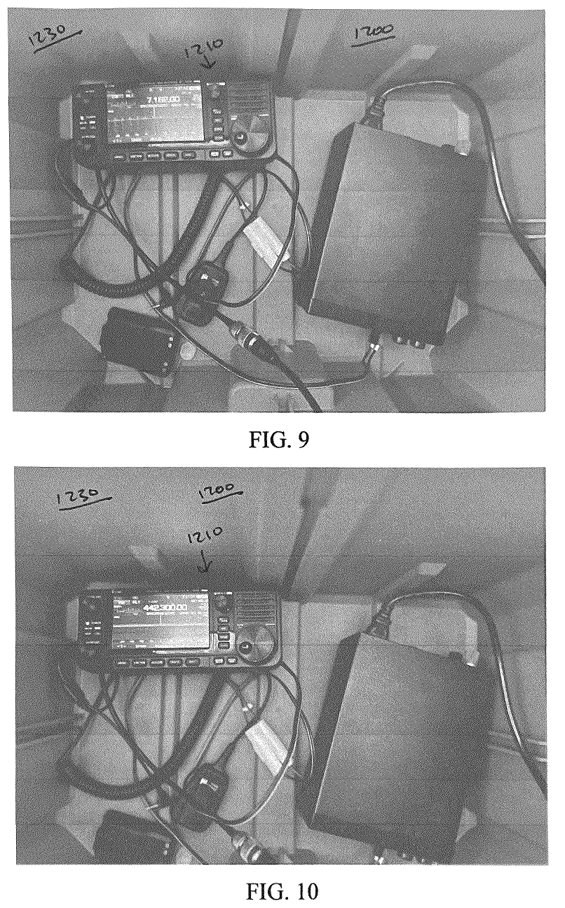

Example telecommunication subsystems 1200 are shown in FIGS. 9-10. Such subsystems 1200 receive power from a power-supplying subsystem 1000. After receiving power, telecommunication subsystems 1200 are capable of reaching very far away (e.g., intercontinental) or relatively close (e.g., local) communication recipients. Telecommunication subsystems 1200 can include a variety of radios 1210. Radios 1210 include emergency radios. Radios 1210 can be selected from a variety of radios sold commercially or made specially. Radios 1210 can include but are not limited to amateur radios (e.g., Ham radios), ultra-high frequency (UHF), very-high frequency (VHF) radios, high-frequency (HF) radios, low-frequency (LF) radios, commercial radios, and any radios suitable to emergency or disaster use. Particularly in emergency or disaster situations where other communication methods may be unavailable, radios may be used in an FM capacity to rebound off of local repeaters to facilitate local, emergency communications.

Telecommunication subsystems 1200 may additionally include antennas 1220. Such antennas 1220 may allow for amplification of signals produced by subsystems 1200. This amplification is especially advantageous in situations where cell phone or landline towers in the vicinity are compromised. A wide variety of antennas 1220 can be used. Larger antennas 1220 may be appropriate in more remote locations or when larger disasters have caused more significant and wide-reaching damage to communication infrastructure. Smaller antennas 1220 may be sufficient in more urban or connected areas. As non-limiting examples, antennas 1220 can be about 10 meters up to about 40 meters in length. As an additional, non-limiting example, antennas 1220 may be about 20 meters up to about 30 meters in length. A particular example of an antenna 1220 may be about 10 meters in length. As a non-limiting example, telescoping antennas 1220 may be used. Telescoping antennas 1220 allow for storage while not being used.

Telecommunication subsystems 1200 may additionally provide internet services including but not limited to Wi-Fi capabilities. Subsystems 1200 may use broadband from satellites to supply internet connectivity in remote or urgent applications. As a non-limiting example, a subsystem 1200 may incorporate a satellite dish to align with satellites to provide internet services. Such a dish may be coupled to a resource system 10 using methods described herein. Such a dish may further be coupled adjustably such that the dish can be raised, lowered, rotated, and otherwise maneuvered to better receive internet services. Such adjustments may be made either manually or through use of automation via one or more actuators.

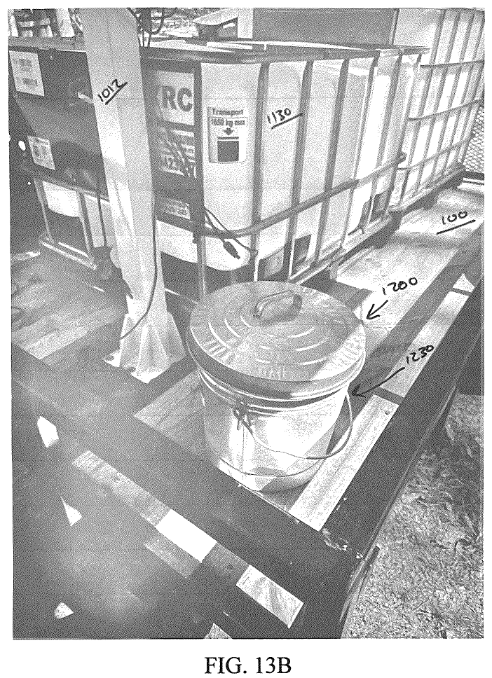

Telecommunication subsystems 1200 may also include housings 1230 similar to housings 1080 of power-supplying subsystems 1000, as shown in FIGS. 9-10. As such, housings 1230 may be waterproof, theft-proof, otherwise nature-proof, and include tracking devices to protect subsystems 1200 from a variety of potential damages. As a non-limiting example, such housings 1230 may also include Faraday cages, as shown in FIGS. 13A-13B. Faraday cages effectively protect any components contained therein (e.g., as a non-limiting example components of a telecommunication subsystem) against a potential electromagnetic pulse (EMP) or any other disturbance known to disrupt electronic functions. Such pulses or disturbances could be caused by a number of sources including but not limited to nearby nuclear explosions. Faraday cages as simple as a metal trash can or other housing may be used, or Faraday cages of increased complexity may be used.

### D. Protective Subsystems 1300

The present disclosure is additionally related to a variety of protective subsystems 1300. Protective subsystems 1300 are capable of protecting the resource system 10 from a variety of potential hazards, dangers, and the like. As a non-limiting example, protective subsystems 1300 may protect the resource system 10 hazards, dangers, and the like that may be encountered during a natural disaster or other emergency as well as human-centric dangers, such as theft and vandalism.

As a non-limiting example, a protective subsystem 1300 may include one or more anchors 1310, as shown in FIG. 12. Anchors 1310 prevent a resource system 10 from being toppled, moved, or otherwise damaged by forces that may affect a resource system 10. As non-limiting examples, anchors 1310 may prevent movement of a system 10 in high winds, high tides, earthquakes, stampedes, and any other occurrence tending to move or damage a resource system 10.

Anchors 1310 include any device capable of securing a resource system 10 to a particular location. As shown in FIGS. 12A-12B, an anchor 1310 may be, as a non-limiting example, a ground anchor (FIG. 12A), a helical anchor (FIG. 12B), a concrete anchor, or any such anchor known in the art capable of anchoring the resource system 10. As previously discussed, water storage devices 1130 may also serve as anchors 1310. As additional, non-limiting examples, an anchor 1310 may include sand bags, water bags, weights, piles, stakes, and the like.

Protective subsystems 1300 may further include armor 1320. Armor 1320 serves to protect resource systems 10 that have been deployed in potentially dangerous locations. As a non-limiting example, a resource system 10 deployed in a war zone, an area frequented by large wild life, an area prone to falling objects, and the like may require armor 1320. Armor 1320 can include a wide variety of devices configured to protect subsystems and components of a resource system 10. As non-limiting examples, armor 1320 may include one or more armored plates, one or more portions of sheet metal, plywood, lumber, or any additional, durable material, one or more portions of Kevlar or other projectile-resistant materials, and the like.

Protective subsystems 1300 may further include theft prevention devices 1330. As subsystems and components of resource systems 10 may be monetarily valuable or otherwise desirable to a robber, theft prevention devices 1330 can be used. Such devices 1330 include a wide variety of devices known to prevent or deter theft. As non-limiting examples, such devices 1330 include but are not limited to locks, tracking devices, metal bars, alarm systems, alerts, and the like.

### E. Power Tool Subsystems 1400

The present disclosure additionally relates to a power tool subsystem 1400. Such a subsystem 1400 can include a variety of power tools that may be useful. As non-limiting examples, power tools include but are not limited to drills, chainsaws, table saws, sanders, and any such power tools that may be useful. In a particular, non-limiting example power tools can be selected that might be particularly useful in emergencies, such as chainsaws. In additional examples, power tools that are useful in building shelter, boats, and other items useful in remote locations may be used. Power tool subsystems 1400 may additionally include outlets for tools to be powered by. Such outlets are capable of being coupled to power-supplying subsystems 1000 to receive power. FIGS. 5-6 display an example configuration of a resource system 10 utilizing a power tool subsystem 1400. In such example, a power tool subsystem 1400 may include charging stations directly coupled to a power-supplying subsystem 1000.

F. Distillation Subsystem 1500

The present disclosure additionally relates to distillation subsystems 1500. In such distillation subsystems 1500, a power-supplying subsystem 1000 can be used to supply the requisite energy to power reactors and distillation columns to produce ethanol-based fuel. As previously discussed, power-supplying subsystems may include wind turbines, solar power, and the like such that renewable energy can be used to continuously distill ethanol-based fuel. Ethanol-based fuel can be produced in a process grinding mash (e.g, corn mash), mixing the ground product with water and an enzyme to create glucose, fermenting this mixture to produce ethanol, and distilling the ethanol-containing mixture to produce ethanol fuel (e.g., biofuel). Such application provides a unique solution to the inability to store renewable (e.g., solar) based power. As a non-limiting example, power from the sun can be used to supply electricity through solar panels. Such solar panels can then power distillation processes, thus “storing” the solar power in ethanol. This represents a conversion from solar power to chemically stored power (i.e. power stored in chemical bonds of ethanol that can be used as fuel for other machinery).

Distillation subsystems 1500 include a variety of components required to continuously produce and distill ethanol to retrieve ethanol of an appropriate purity to power ethanol-based machinery and devices. Such components include but are not limited to a corn mill 1510, a corn steep tank 1520, an ethanol fermenter 1530, one or more filtration systems 1540, a physical separation device 1550, a distillation column 1560, and a storage tank 1570 for produced ethanol. Physical separation devices 1550 include but are not limited to centrifuges and other such devices. Distillation techniques for producing ethanol-based fuels from corn and other produce and cellulosics are capable of being implemented by the distillation subsystem 1500.

Distillation subsystems 1500 could be particularly efficient when pulled on a resource system 100 that is coupled to a truck capable of running on ethanol. In such example embodiments, a truck could retrieve a feedstock from a given location, turn the feedstock into ethanol, and run the truck itself on the produced ethanol. Such an embodiment would then leave additional ethanol not used for fueling the truck to be used to fuel other machinery, such as by burning organic byproducts.

### G. Additional Subsystems and Components

The present disclosure relates to a wide variety of additional subsystems and components capable of being coupled to the body 100 of a resource system 10. Such subsystems and components can be coupled to and configured with other subsystems disclosed herein. As non-limiting examples, additional subsystems and components can be coupled to power-supplying subsystems 1000, water-producing subsystems 1100, telecommunication subsystems 1200, and any other subsystems and components disclosed herein. Such additional subsystems and components can provide a wide range of functionalities that may be required in various locations and applications. A non-exhaustive, example list of additional subsystems and components are disclosed below, though additional subsystems and components are also capable of being used with resource systems 10.

The present disclosure relates to refrigeration or air conditioning subsystems 1400. Such subsystems 1400 can allow for food storage. Such subsystems 1400 can additionally provide air conditioning in areas where it is required. As a non-limiting example, air conditioning can be provided to elderly individuals in hot areas where power has gone out. In such an example, air conditioning can be a useful resource to prevent overheating of those particularly susceptible to elevated temperatures. As an additional, non-limiting example, air conditioning may be desirable in less dire situations. In such examples, air conditioning subsystems 1400 can provide comfort in remote locations, such as for recreational vehicles (RVs) traveling to remote lakes, deserts, mountains, or the like.

The present disclosure additionally relates to cooking subsystems 1500. As non-limiting examples, cooking subsystems 1500 include a variety of appliances capable of producing edible foodstuffs. As non-limiting examples, cooking subsystems 1500 include hot plates, ovens, microwaves, electric grills, air fryers, and any other such appliances. Such subsystems 1500 can be coupled to power-supplying subsystems 1000 to provide power.

The present disclosure relates to a variety of other subsystems that can be coupled to a power-supplying subsystem 1000. Such additional subsystems may be coupled to an outlet connected to a power-supplying subsystem 1000. As non-limiting examples, additional subsystems include but are not limited to charging stations for phones, tablets, computers, and the like, lighting subsystems including bright lighting subsystems, speaker subsystems including loudspeaker subsystems, and any other such electronic devices. In a particular, non-limiting example lighting subsystems may be useful in disaster situations to alert nearby individuals of the presence of a resource system 10. In an additional, particular, non-limiting example, speaker subsystems may allow an operator to communicate to crowds of people in a disaster-stricken area. As such, an operator may communicate the subsystems coupled to a resource system 10. This will alert nearby individuals of services being provided.

As mentioned above, the aforementioned subsystems and components are merely examples of the disclosure provided herein. Any need that may arise in a remote, disaster-stricken, emergency, recreational, or other such location can be met by coupling an additional subsystem to a body 100 of a mobile, modular resource system 10.

### II. Example Configurations of Systems

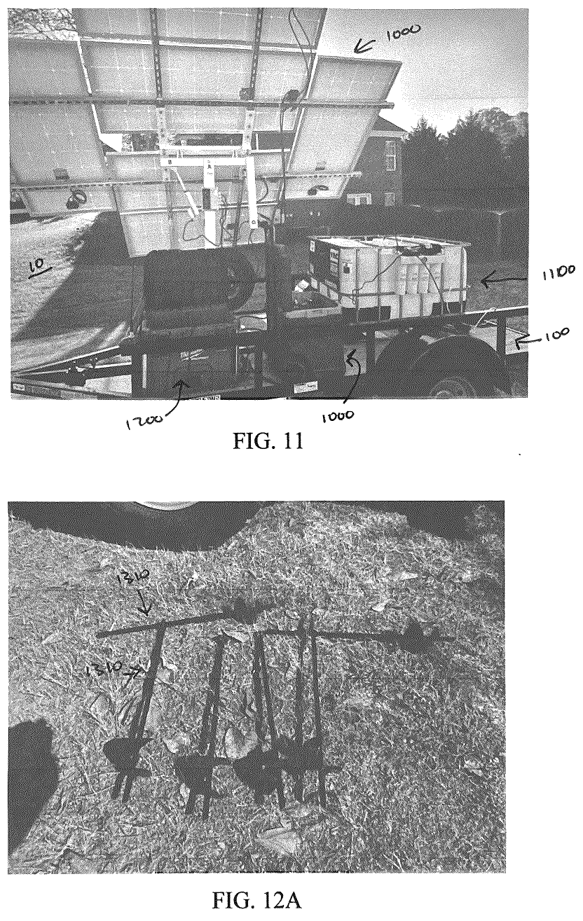

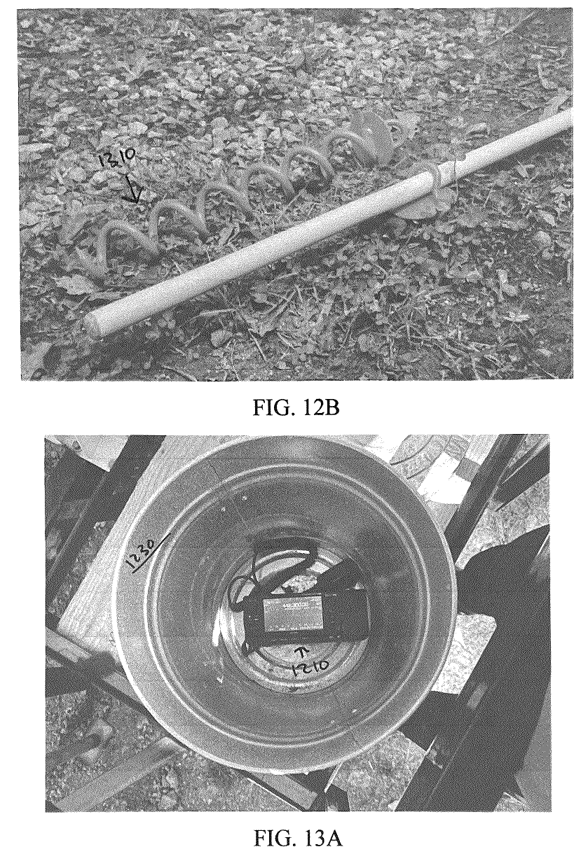

The present disclosure relates to a number of example configurations suitable for a wide variety of applications, as shown in FIGS. 5, 11, and 14-16. As described above, subsystems and components are modular. The modularity of such subsystems and components allows for a mobile, modular resource system 10 to be fitted with any combination of subsystems and components. Some applications may require particular subsystems and components while other applications may not. Subsystems and components can be attached, detached, re-configured, and the like at will by an operator. This presents a widely adaptable resource system 10. Several non-limiting examples of potential configurations are disclosed below, though it is to be understood that many more are possible.

The present disclosure relates, as a non-limiting example, to a minimalistic configuration. Such a configuration may include only bare necessities that an operator may need. A minimalistic configuration, as a non-limiting example, may include a body 100, wheels 200, a power-supplying subsystem 1000, and a water-producing subsystem 1100. Such a system 1000 can easily be taken to remote areas for recreational purposes. As such, an operator can access renewable energy to power devices and produce potable drinking water without having to carry large stocks of water to the site.

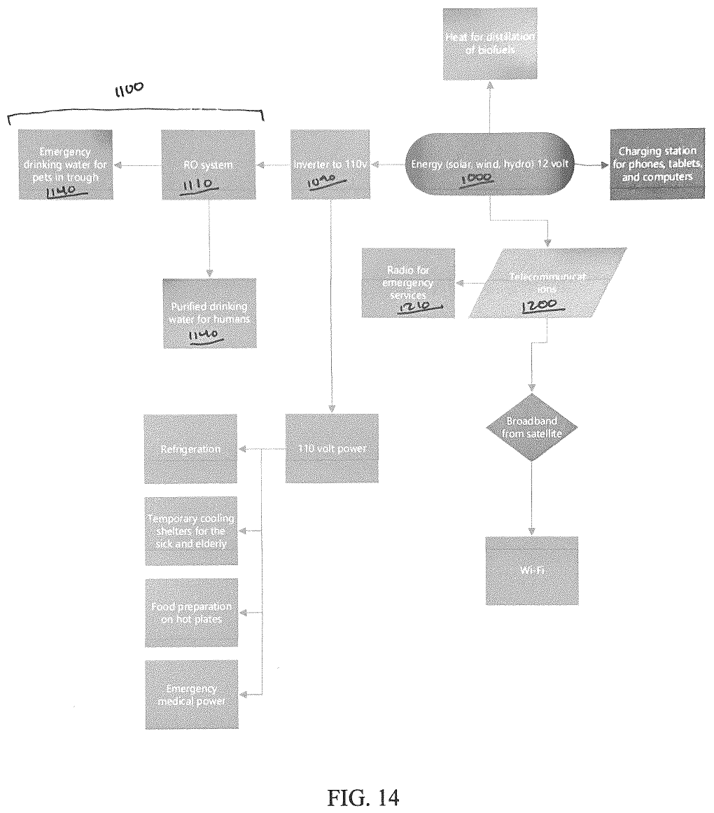

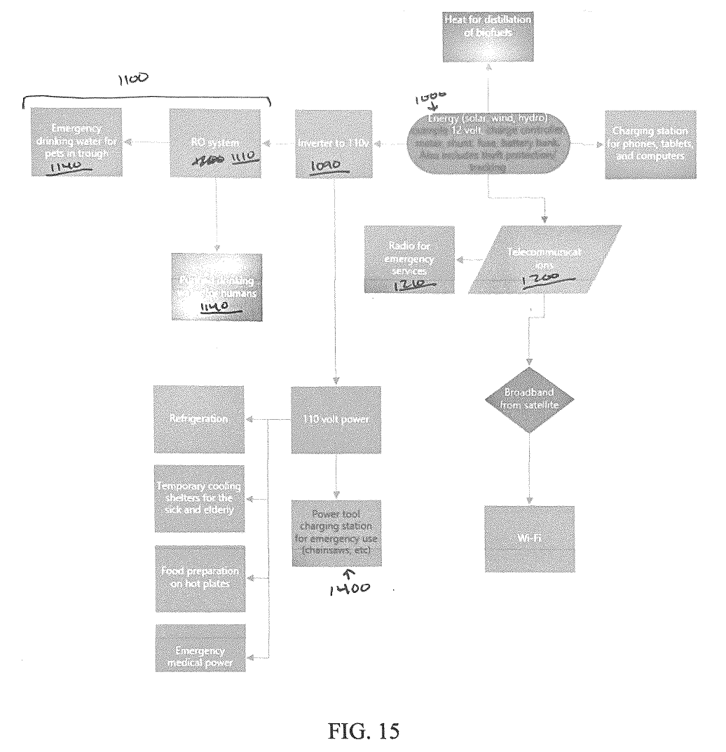

The present disclosure additionally relates to, as non-limiting examples, recreational configurations capable of including a variety of other subsystems and components described herein. As shown in FIG. 14, a recreational configuration may additionally include telecommunications subsystems 1200, refrigeration units, food preparation units, charging stations, and the like. As shown in FIG. 15, such configurations can additionally include power tool subsystems 1400.

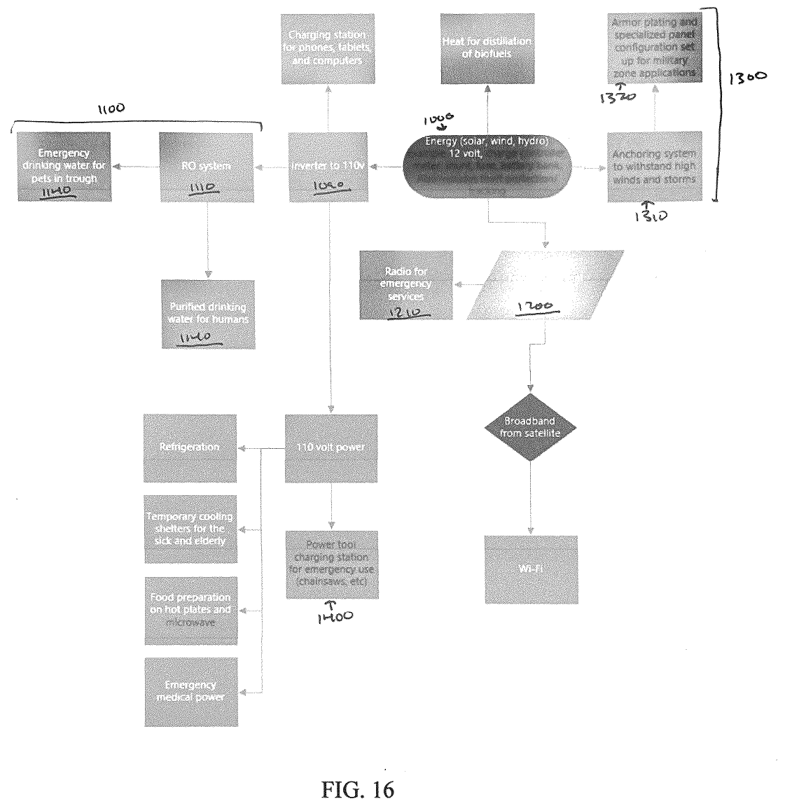

The present disclosure relates to, as non-limiting examples, emergency or disaster configurations. Such configurations are suitable for being transported to the site of an emergency or disaster. In such applications, water lines, power lines, and communication lines may have been adversely impacted by the cause of the emergency or disaster. As a non-limiting example, a hurricane may have wiped out many sources of necessities. A mobile, modular resource system 10 can be configured to address such a situation. In an example embodiment, as shown in FIG. 16, a system 10 to be used in disasters may include power-supplying subsystems 1000, water-producing subsystems 1100, telecommunication subsystems 1200, protective subsystems 1300, and additional subsystems and components necessitated by the particular emergency.

Although several aspects have been disclosed in the foregoing specification, it is understood by those skilled in the art that many modifications and other aspects will come to mind to which this disclosure pertains, having the benefit of the teaching presented in the foregoing description and associated drawings. It is thus understood that the disclosure is not limited to the specific aspects disclosed hereinabove, and that many modifications and other aspects are intended to be included within the scope of any claims that can recite the disclosed subject matter.

It should be emphasized that the above-described aspects are merely possible examples of implementations, merely set forth for a clear understanding of the principles of the present disclosure. Any process descriptions or blocks in flow diagrams should be understood as representing modules, segments, or portions of code which comprise one or more executable instructions for implementing specific logical functions or steps in the process, and alternate implementations are included in which functions may not be included or executed at all, can be executed out of order from that shown or discussed, including substantially concurrently or in reverse order, depending on the functionality involved, as would be understood by those reasonably skilled in the art of the present disclosure. Many variations and modifications can be made to the above-described aspect(s) without departing substantially from the spirit and principles of the present disclosure. Further, the scope of the present disclosure is intended to cover any and all combinations and sub-combinations of all systems, subsystems, components, elements, features, and aspects discussed above. All such modifications and variations are intended to be included herein within the scope of the present disclosure, and all possible claims to individual aspects or combinations of elements or steps are intended to be supported by the present disclosure.

We claim:

1. A modular, mobile resource system for providing resources, the modular, mobile resource system comprising:
a. a body including at least a floor, wherein the body is configured to receive various subsystems and components;
b. a wheel subsystem, wherein the wheel subsystem allows the body to be transported; and
c. a power-supplying subsystem, wherein the power-supplying subsystem is coupled to at least a portion of the body.

2. The modular, mobile resource system of claim 1, wherein the body comprises a width of about 2 feet up to about 10 feet and a length of about 3 feet up to about 60 feet.

3. The modular, mobile resource system of claim 1, wherein the body further comprises at least one wall capable of receiving various subsystems and components.

4. The modular, mobile resource system of claim 1, wherein the body comprises a material selected from wood, metals, hard plastics, fiberglass, and carbon fiber.

5. The modular, mobile resource system of claim 1, wherein the wheel subsystem includes at least two wheels and an axle.

6. The modular, mobile resource system of claim 1, wherein the power-supplying subsystem includes a renewable power source.

7. The modular, mobile resource system of claim 6, wherein the renewable power source is a solar panel, an array of solar panels, a wind turbine, an array of wind turbines, a hydro turbine, an array of hydro turbines, or any combinations thereof.

8. The modular, mobile resource system of claim 1, wherein the power-supplying subsystem includes charge controllers to prevent battery shorting, charge meters, shunts, fuses, battery banks, control units, a housing unit, and any combinations thereof.

9. The modular, mobile resource system of claim 8, wherein battery banks include deep cell batteries, sealed lead acid batteries, lithium ion batteries, or hydrogen fuel cells.

10. The modular, mobile resource system of claim 1, wherein the power-supplying subsystem is capable of supplying power to a variety of other subsystems and components.

11. The modular, mobile resource system of claim 10, wherein the power-supplying subsystem is capable of supplying power to water-producing subsystems, telecommunication subsystems, distillation subsystems, power tool subsystems, refrigeration subsystems, air conditioning subsystems, cooking subsystems, charging stations for phones, tablets, and computers, lighting subsystems, and speaker subsystems.

12. The modular, mobile resource system of claim 1 further comprising a water-producing subsystem, the water-producing subsystem comprising:
a. a filtration system capable of converting dirty water into potable water;
b. a booster pump to increase water flow to the filtration system;
c. a water storage device to hold potable water; and
d. a water cleaning unit disposed within the water storage device.

13. The modular, mobile resource system of claim 11, wherein the water-producing subsystem further comprises water-dispersion units.

14. The modular, mobile resource system of claim 1 further comprising a telecommunication subsystem.

15. The modular, mobile resource system of claim 13, wherein the telecommunication subsystem comprises at least one radio, an antenna, and a Wi-Fi capable device.

16. The modular, mobile resource system of claim 14, wherein the telecommunication subsystem comprises at least one Faraday cage to protect against a potential electromagnetic pulse or disturbance.

17. The modular, mobile resource system of claim 1 further comprising at least one protective subsystem.

18. The modular, mobile resource system of claim 17, wherein the at least one protective subsystem is selected from systems including anchors, armoring, and theft prevention devices.

19. The modular, mobile resource system of claim 1 further comprising power tool subsystems, wherein power tool subsystems comprise a number of power tools and outlets to power the number of power tools.

20. The modular, mobile resource system of claim 1 further comprising a distillation subsystem, wherein the distillation subsystem comprises a mill, a steep tank, an ethanol fermenter, one or more filtration systems, a physical separation device, a distillation column, and a storage tank to produce ethanol.
